(19) United States
(12) Patent Application Publication
(10) Pub. No.: US 2018/0257081 A1
(43) Pub. Date: Sep. 13, 2018

(54) METHOD AND SYSTEM FOR RECYCLING RUBBER

(71) Applicants: Ralph Howard THOMPSON, Rock Creek, OH (US); Brian Albert HARVEY, Twinsburg, OH (US)

(72) Inventors: Ralph Howard THOMPSON, Rock Creek, OH (US); Brian Albert HARVEY, Twinsburg, OH (US)

(21) Appl. No.: 15/916,463

(22) Filed: Mar. 9, 2018

Related U.S. Application Data
(60) Provisional application No. 62/469,002, filed on Mar. 9, 2017.

(51) Int. Cl. B02C 7/08; B02C 7/17; B29B 7/74; B29B 13/06; B29B 17/04; B29B 9/06

(52) U.S. Cl. CPC B02C 7/08; B02C 7/17; B29B 7/7495; B29B 13/065; C08J 11/06; B29B 17/0404; B29B 9/06; B29B 2017/0484; B29B 17/0412

(57) ABSTRACT

Provided is a method of recycling rubber including grinding rubber to be recycled, drying said rubber in a heated, vertically-oriented blender, compressing the rubber in a compressor, and extruding the rubber through an extruder and onto a conveyor. Also provided is a system for carrying out the method and recycled rubber product produced by the same.

This application is claims the benefit of the filing date under 35 U.S.C. § 119(e) of U.S. Provisional Application for Patent Ser. No. 62/469,002, filed Mar. 9, 2017, which is incorporated herein by reference.

### TECHNICAL FIELD

The present disclosure relates to a method and system for recycling rubber, as well as the recycled rubber product made by the method.

### BACKGROUND

There are two main scrap designations commonly known to producing polymers: “IP,” a common term for by-product of the reactor that didn't achieve the full reactor cycle, but has the physical properties of the polymer, and “PCU,” process contaminated units that comprise excess dirt, volatiles, and moisture.

Two methods of recycling rubber or rubber scrap known in the art are the traditional tangential mixer and conical extruder methods. Some methods and systems for recycling rubber cut the raw material to be recycled through a series of guillotines in order to reduce the material to a desired size before processing. The preprocessed rubber is then placed into a mixer in order to homogenize the preprocessed rubber and ensure that the rubber composition is appropriate for its intended product. After the mixing process, the rubber is transferred to a conical extruder where it is pelletized and mixed with a water/anti-tack solution and extruded onto a conveyor for drying. The rubber then proceeds to compression equipment in order to produce the finished recycled rubber product.

What is needed are systems and/or methods which improve upon the quality and efficiency of the rubber recycling process, are able to process both IP and PCU scrap designations, and produce a recycled rubber product that more closely meets the specifications of the recycled rubber market. An area of interest is improving the energy efficiency and flexibility of the system to accommodate various source rubbers.

### SUMMARY

Disclosed herein is a method of recycling rubber, comprising grinding rubber to be recycled, substantially drying said rubber in a heated, vertically-oriented blender, compressing said dried rubber in a compressor, and extruding the rubber through an extruder and onto a conveyor.

Also disclosed herein is the product of the method.

Further disclosed herein is a system for recycling rubber, comprising a grinder, a vertically-oriented dryer, a compressor, an extruder.

### BRIEF DESCRIPTION OF THE DRAWING

The accompanying drawings are included to provide a further understanding of the system and method provided herein, and are incorporated in and constitute a part of this specification. The drawing illustrates certain embodiments of the system and method disclosed herein and, together with the description, serve to explain the principles described herein, but are not intended to limit the specification or any of the claims.

FIG. 1 is a block diagram of one illustrative embodiment of the present rubber recycling method.

FIG. 2 is a view of a vertically-oriented dryer.

### DETAILED DESCRIPTION

The disclosed embodiments process rubber waste from polymer plant recycling by removing volatiles and moisture from the scrap, permitting the recycling of polymers to become a near prime product. If the material becomes waste without being cross-linked, the actual ingredient will release toxic waste into the earth and atmosphere.

The disclosed system and methods reduce mechanical sheering while removing volatiles and moisture, while maintaining the physical properties of the original polymer. The physical design conserves molecular energy, allowing the polymer to retain more of its original properties. As a result, the end product is a closer equivalent to non-recycled, or “prime,” materials, and results in less product becoming waste.

A rubber recycling method is disclosed. According to certain illustrative embodiments, the method includes grinding the rubber to be recycled. The ground rubber is dried in a blender. According to certain embodiments, the ground rubber is dried in a vertically-oriented blender. The vertically oriented blender may be, without limitation, open to the atmosphere at the top end and operating at atmospheric pressure. According to certain embodiments, the ground rubber is dried in a heated and vertically-oriented blender. According to certain illustrative embodiments, the ground and dried rubber is compressed in a compressor. According to certain illustrative embodiments, the rubber is extruded through an extruder. According to certain illustrative embodiments, the ground, dried, compressed rubber is extruded through an extruder. According to certain illustrative embodiments, the extruded rubber is extruded onto a conveyor.

The process may be used to recycle any natural or synthetic rubber, or combinations thereof. The rubber to be recycled may be, without limitation, natural rubber, bromobutyl, chlorobutyl, butyl, chloroprene, neoprene, epichorohydrin, fluorel chlorohydrin, ethylene propylene diene, silicone rubber, nitrile, (synthetic) natural, polyurethane, or carboxylated nitrile rubber. The rubber may be previously used rubber to be recycled or PCU or IP scrap.

According to certain illustrative embodiments, the rubber may be shredded before it is ground. Shredding may be carried out, without limitation, via guillotine method, using a series of spaced-apart discs with upper and lower cutting blades. Suitable shredding methods are disclosed in U.S. Pat. Nos. 3,727,850, 5,474,239, and 7,182,285, each of which are incorporated herein by reference.

The rubber to be recycled proceeds through a grinding process. The grinding may proceed in one grinder or with multiple grinders operating in parallel. The grinding may proceed, without limitation, via tub grinding, horizontal grinding, chipping, hammer milling, hogging, and/or shredding. Suitable rubber grinding methods are disclosed in U.S. Pat Nos. 5,507,441, 5,419,502, 5,975,443, 5,947,395, 6,299,082, 6,840,471, 7,959,09, and 9,186,683, each of which are incorporated herein by reference. Grinding may proceed with the use of a lubricant. According to certain illustrative embodiments, said lubricant may comprise talc powder. According to certain illustrative embodiments, said lubricant may comprise water. According to certain illustrative embodiments, grinding may proceed with the use of a fluid slurry. According to certain illustrative embodiments, the grinder may be equipped with a screened discharge, ensuring discharged particles are limited by size. According to certain embodiments and without limitation, the grinder may be the Mitts & Merrill Rubber Hog or the Bottom Discharge Hog available from Jordan Reduction Solutions (Birmingham, Ala.).

The rubber proceeds to a drying process after the grinding and optional shredding steps. The drying step may proceed in one dryer or in multiple dryers in parallel receiving ground rubber from the at least one grinder. Drying may occur in a vertically-oriented dryer. The vertically-oriented dryer comprises a longitudinal axis substantially perpendicular to the surface of the earth and a horizontal axis substantially parallel to the surface of the earth, wherein the longitudinal axis is larger than the horizontal axis. According to certain embodiments, the vertically-oriented dryer may be open to the atmosphere at the top surface. According to certain embodiments, the vertically-oriented dryer may be open to the atmosphere. According to certain embodiments, the vertically-oriented dryer may be heated by an external heating jacket. According to certain embodiments, the external heating jacket may be heated by electrical heater, gas heat, flame heating, hot water circulation, or some combination of the these methods. According to certain embodiments, the heating jacket may surround at least a portion of the vertically-oriented dryer. According to some embodiments, the heating jacket may circumscribe the vertically-oriented dryer. The dryer may, without limitation, include an external motor connected to a shaft, wherein the motor turns the shaft, which turns a helically-shaped spiral mixing ribbon within a substantially conical body, wherein the mixing ribbon pulls contents from the bottom of the dryer upward while gravity drives the contents at the bottom of the dyer downward. The at least one dryer may be, without limitation, the Eagle Verti-Mix Ribbon Mixer available from the Eagle Group Ltd. (Greenville, Mich.).

According to some embodiments, a chemical or chemical mixture may be added to the rubber for the purpose of fortifying the rubber. This chemical may be added in the dryer. The chemical or chemical mixture added to the rubber may comprise an inorganic oxide particulate. The inorganic oxide particulate may be a metal oxide particulate. According to some embodiments, the chemical or chemical mixture may comprise aluminum oxide. According to some embodiments, the chemical or chemical mixture may comprise calcium oxide. According to some embodiments, the chemical or chemical mixture may comprise iron oxide. According to some embodiments, the chemical or chemical mixture may comprise titanium oxide. According to some embodiments, the chemical or chemical mixture may comprise silicon dioxide. According to some embodiments, the chemical or chemical mixture may be Fortimix®, available from the SEFA Group® (Lexington, S.C.). According to some embodiments, asphalt or polyethylene-terephthalate (PET) may be added. According to some embodiments, any or all of the chemical or chemical mixtures may be excluded.

According to some embodiments, a binder may be added. The binder may be polyurethane, polyurea, hybrid polyurea-polyurethane, or mixtures thereof based. The binder may be added via continuous or batch addition. According to other embodiments, the method may proceed without additional binder.

The moisture content of the ground rubber should not proceed from the drying process until the rubber is between about 0% and about 1% moisture by weight and about 170 degrees F. to about 190 degrees F. Therefore, according to some embodiments, the drying process includes moisture and/or temperature monitoring. According to some embodiments, the moisture content of the ground rubber does not proceed from the drying process until the rubber is between about 0% and about 0.8% moisture. According to some embodiments, the moisture content of the ground rubber does not proceed from the drying process until the rubber is between about 0% and about 0.5% moisture. According to some embodiments, the temperature of the rubber is about 170 degrees F. to about 190 degrees F. after drying. According to some embodiments, the temperature of the rubber is about 175 degrees F. to about 185 degrees F. after drying. According to some embodiments, the temperature of the rubber is about 180 degrees F. after drying. According to certain embodiments and without limitation, the moisture and/or temperature monitor may be the Eriez Moisture Monitor available from Eriez® (Erie, Pa.).

After drying, the rubber then proceeds to a compression step. The compression of the dried rubber may proceed in one compressor or in multiple compressors in parallel receiving dried rubber from the at least one dryer. Compression aids in maintaining a uniform output and evacuates trapped air from the rubber. According to some embodiments and without limitation, the compression may proceed in the feed section of the 200 mm NFM/Monsanto 22:1 l/d Vented Extruder available from NFM Polymer Processing Systems & Solutions (Massillon, Ohio).

After compression, the rubber is fed to an extruder. The extrusion process may proceed in one extruder or in multiple extruders in parallel receiving ground, dried, compressed rubber from the at least one compressor. The at least one compressor may be, without limitation, the 200 mm NFM/Monsanto 22:1 1/d Vented Extruder available from NFM Polymer Processing Systems & Solutions (Massillon, Ohio).

According to some embodiments, the extrusion process results in substantially uniform extruded rubber pellets ranging in temperature at the time of extrusion from about 210 degrees F. to about 240 degrees F. According to some embodiments, the extrusion process results in substantially uniform extruded rubber pellets ranging in temperature at the time of extrusion from about 215 degrees F. to about 235 degrees F. According to some embodiments, the extrusion process results in substantially uniform extruded rubber pellets ranging in temperature at the time of extrusion from about 220 degrees F. to about 230 degrees F.

According to some embodiments, the rubber pellets vary from about 1/16 inch to about 1 inch in diameter. According to some embodiments, the rubber pellets vary from about 3/32 inch to about ¾ inch in diameter. According to some embodiments, the rubber pellets vary from about ⅛ inch to about ½ inch in diameter.

According to some embodiments, the rubber pellets contain a maximum of about 1% to about 5% air by volume. According to some embodiments, the rubber pellets contain a maximum of about 2% to about 4% air by volume. According to some embodiments, the rubber pellets contain a maximum of about 3% air by volume.

According to some embodiments, the tensile strength, elongation, and 300% modulus of the rubber is between about 70% to about 100% of its prime value. According to some embodiments, each of the tensile strength, elongation, and 300% modulus of the rubber is between about 80% to about 100% of its prime value. According to some embodiments, each of the tensile strength, elongation, and 300% modulus of the rubber is between about 90% to about 100% of its prime value.

According to some embodiments, after extrusion, the rubber is permitted to cool. The cooling process may proceed via one cooling conveyor or in multiple cooling conveyors operating in parallel. The cooling process may proceed, without limitation, by carrying the extruded rubber pellets on a steel belt type conveyor. According to some embodiments, the cooling is aided by air circulation with fans. According to some embodiments, the fans are shrouded fans. The belt type convey may be, without limitation, a flat wire, weaved, or hinged steel belt type conveyor. According to some illustrative embodiments, the cooling may proceed via the Cooling/Drying Conveyor available from Titan Industries, Inc. (New London, Wis.).

According to some embodiments, after cooling, the rubber is bailed into uniform packages. Bailing is the forming of the product into substantially uniform shapes that aid packaging and distribution, as well as any necessary wrapping. Bailing may proceed in one bailer or in multiple bailers operating in parallel. The bailing process may proceed, without limitation, on a Model FIL-24-32CV Shrinkwrapping and Packing Equipment available from Poly Pack (Pinellas, Fla.).

According to some embodiments, the rubber is pre-collated onto the inline feed conveyor of the bailer, then proceeds to a forming head that encloses the rubber in film. The enclosed rubber then proceeds to a heat seal bar assembly which cuts and seals the film enclosing and trailing the rubber. The enclosed and sealed rubber then travels through a heat tunnel. According to some embodiments, the heat tunnel may be a single fan heat tunnel. In the heat tunnel, the film shrinks to fit tightly around the rubber and seal any remaining unsealed portions.

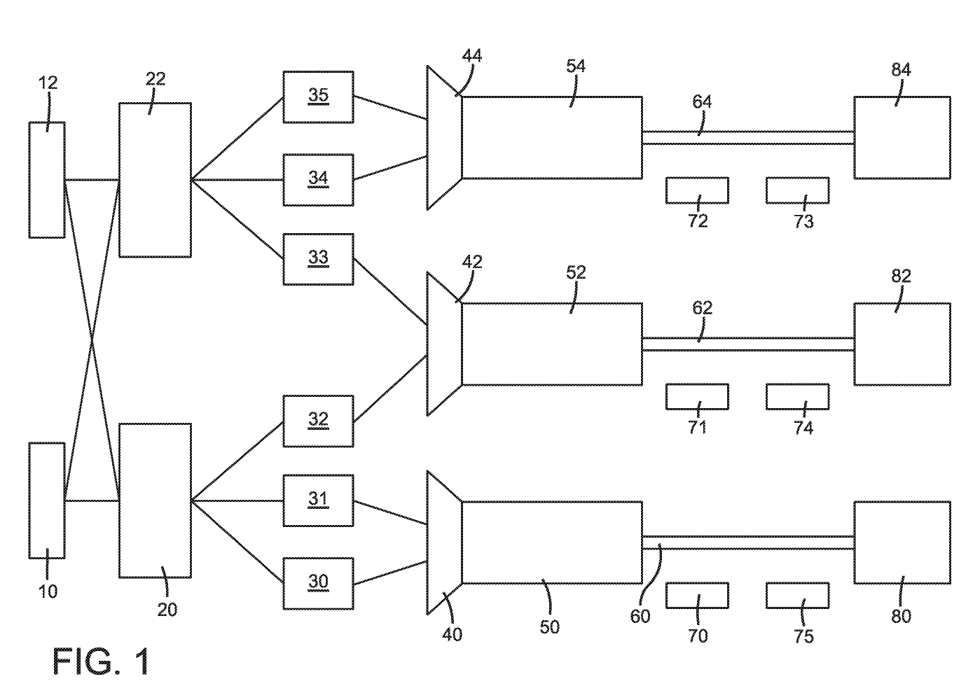

In particular and referring to FIG. 1, there is shown an illustrative rubber recycling system. The rubber recycling system includes shredders 10, 12, grinders 20, 22, vertically-oriented dryers 30-35, compressors 40, 42, 44, extruders 50, 52, 54, cooling conveyors 60, 62, 64, shrouded fans 70-75, and bailers 80, 82, 84.

According to the illustrative embodiments shown in FIG. 1 and without limitation, rubber enters the system into at least one of the shredders 10, 12, where it is cut to have at least one dimension suitable for further processing. The rubber proceeds to at least one grinder 20, 22, where it is ground into particles. The rubber is then fed into at least one dryer 30-35, where moisture is monitored to ensure that the moisture content of the dried rubber is about 0% to about 1% prior to exiting the dryer 30-35. The dried rubber is then fed into at least one compressor 40, 42, 44, where the rubber particles are compressed to decrease and/or remove excess air. From the compressor 40, 42, 44, the rubber enters at least one extruder 50, 52, 54 where the rubber is heated and formed into substantially uniform pellets. From the extruder 50, 52, 54, the pellets are cooled on at least one conveyor 60, 62, 64. Cooling is aided by shrouded fans 70-75, which circulate air near and/or around the rubber to aid cooling. After being cooled, the rubber is fed into at least one bailer 80, 82, 84. At the bailer 80, 82, 84, the pelletized rubber is packaged in shrinkwrap into uniform bails.

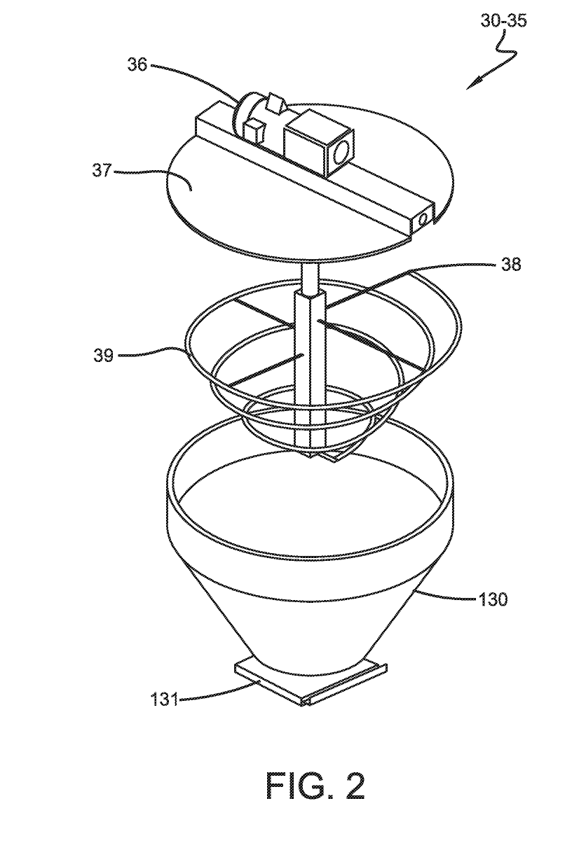

In particular and referring to FIG. 2, there is shown a view of a vertically-oriented dryer 30-35 that may be used herein. The vertically-oriented dryer includes a motor 36, hinged top portion 37, shaft 38, ribbon 39, shell 130, and bottom portion 131. The motor 36 is attached to the hinged top portion 37 and connected to the shaft 38. The motor 36 turns the shaft 38, which in turn rotates the ribbon 39. The ribbon 39, being helically wound, pushes any contents near the bottom 131 upward while gravity forces the contents nearer the top 37 downward. The shell 130 is substantially conical, smaller near the bottom 131 than nearer the top 37. The top 37 is hinged, and may be at least partially open, ensuring the dryer works at atmospheric pressure.

In a first embodiment, provided is a method of recycling rubber, comprising: grinding rubber to be recycled; drying said rubber in a heated, vertically-oriented blender; compressing the rubber in a compressor; and extruding the rubber through an extruder and onto a conveyor.

The method of the first embodiment may include cooling the rubber after extrusion on a steel belted conveyor with shrouded fans.

The method of the first or any subsequent embodiment may further provided that wherein said drying occurs via dry air circulation drying.

The method of the first or any subsequent embodiment may further provided that said drying occurs at ambient pressure.

The method of the first or any subsequent embodiment may include shredding the rubber before grinding.

The method of the first or any subsequent embodiment may include monitoring the moisture content of the rubber.

The method of the first or any subsequent embodiment may further provided that moisture content of the rubber is about 0% to about 0.5% after drying.

The method of the first or any subsequent embodiment may further provided that the rubber extruded from the extruder is at a temperature from about 220 degrees F. to about 230 degrees F.

The method of the first or any subsequent embodiment may include bailing the rubber. In a second embodiment, provided is the recycled rubber produced by the method of the first embodiment.

In a third embodiment, provided is a system for recycling rubber, comprising: a grinder; vertically-oriented dryer; a compressor; and an extruder.

The third or any subsequent embodiment may further include a steel belted conveyor and shrouded fans.

The third or any subsequent embodiment may further include a shredder.

The third or any subsequent embodiment may further include a moisture monitor.

The third or any subsequent embodiment may further include a heating blanket circumscribing at least a portion of the vertically-oriented dryer.

The third or any subsequent embodiment may further provide that the vertically-oriented dryer is at ambient pressure.

The third or any subsequent embodiment may further provide that the extruder is configured to extrude rubber at a temperature from about 220 degrees F. to about 230 degrees F.

The third or any subsequent embodiment may further include a bailer.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A method of recycling rubber comprising:
(a) grinding rubber to be recycled;
(b) drying said rubber in a heated, vertically-oriented blender;
(c) compressing said rubber in a compressor; and
(d) extruding said rubber through an extruder and onto a conveyor.

2. The method of claim 1, comprising cooling the rubber after said extruding on a steel belted conveyor with shrouded fans.

3. The method of claim 1, wherein said drying comprises dry air circulation drying.

4. The method of claim 3, wherein said drying occurs at ambient pressure.

5. The method of claim 1, comprising shredding the rubber before grinding.

6. The method of claim 1, comprising monitoring the moisture content of the rubber.

7. The method of claim 1, wherein moisture content of said rubber is about 0% to about 1% after drying.

8. The method of claim 1, wherein moisture content of said rubber is about 0% to about 0.8% after drying.

9. The method of claim 1, wherein moisture content of said rubber is about 0% to about 0.5% after drying.

10. The method of claim 1, wherein the rubber extruded from the extruder is at a temperature from about 210 degrees F. to about 240 degrees F.

11. The method of claim 1, wherein the rubber extruded from the extruder is at a temperature from about 215 degrees F. to about 235 degrees F.

12. The method of claim 1, wherein the rubber extruded from the extruder is at a temperature from about 220 degrees F. to about 230 degrees F.

13. The method of claim 1, further comprising bailing the rubber.

14. Recycled rubber produced by the process of any of claim 1.

15. A system for recycling rubber comprising:
(a) at least one grinder;
(b) at least one vertically-oriented dryer;
(c) at least one compressor; and
(d) at least one extruder.

16. The system of claim 15, further comprising at least one steel belted conveyor and shrouded fans, wherein said at least one steel belted conveyor is configured to receive rubber from said extruder.

17. The system of claim 15, further comprising at least one of the group consisting of a t least one shredder, at least one moisture monitor, at least one bailer, and at least one heating jacket surrounding at least a portion of the at least one vertically-oriented dryer, wherein the at least one vertically-oriented dryer is capable of operating at ambient pressure, and combinations thereof.

18. The system of claim 15, wherein the at least one extruder is configured to extrude rubber at a temperature from about 210 degrees F. to about 240 degrees F.

19. The system of claim 15, wherein the at least one extruder is configured to extrude rubber at a temperature from about 215 degrees F. to about 235 degrees F.

20. The system of claim 15, wherein the at least one extruder is configured to extrude rubber at a temperature from about 220 degrees F. to about 230 degrees F.
